(19) United States
(12) Patent Application Publication
(10) Pub. No.: US 2013/0246155 A1
(43) Pub. Date: Sep. 19, 2013

(54) DIGITAL CONTENT PURCHASE OFFERS VIA SET-TOP BOX

(71) Applicants: Venket S. Kandanala, Highland Village, TX (US); Nicky Pinakin Joshi, Flower Mound, TX (US); Sudharsan Selvakumar, Irving, TX (US); Lisa A. Caputo, Dade City, FL (US); Mousumi Dasgupta, Irving, TX (US); Nisheeth Gupta, Irving, TX (US); Karthik Srinivasan, Flower Mound, TX (US); Rajesh Narayanan, Chennai (IN); Anand N. Sankaran, Chennai (IN); Jubish C. Parambath, Chennai (IN)

(72) Inventors: Venket S. Kandanala, Highland Village, TX (US); Nicky Pinakin Joshi, Flower Mound, TX (US); Sudharsan Selvakumar, Irving, TX (US); Lisa A. Caputo, Dade City, FL (US); Mousumi Dasgupta, Irving, TX (US); Nisheeth Gupta, Irving, TX (US); Karthik Srinivasan, Flower Mound, TX (US); Rajesh Narayanan, Chennai (IN); Anand N. Sankaran, Chennai (IN); Jubish C. Parambath, Chennai (IN)

(73) Assignee: VERIZON PATENT AND LICENSING INC., Basking Ridge, NJ (US)

(21) Appl. No.: 13/421,083

(22) Filed: Mar. 15, 2012

(51) Int. Cl. G06Q 30/02

(52) U.S. Cl. 705/14.35

(57) ABSTRACT

A network device receives details of a purchase offer for digital content, where the purchase offer includes a price for the digital content at a required customer purchasing participation threshold, and where the required customer purchasing participation threshold includes a number of customers that must agree to purchase the digital content at the price for the purchase offer to be fulfilled. The network device targets multiple customers based on customer profile data, and presents the purchase offer to the multiple customers, via multiple different devices associated with respective ones of the multiple customers, during the offer period. The network device charges participating customers the purchase offer price, if the purchasing participation threshold is reached by expiration of the offer period; and notifies the participating customers of expiration of the purchase offer, if the purchasing participation threshold is not reached by the expiration of the offer period.

### BACKGROUND

Set-Top Boxes (STBs) are used for selecting among channels on a network, such as, for example, a cable network (e.g., an optical fiber network) to enable content transmitted on those channels to be displayed on display devices (e.g., televisions) connected to the STBs. The STB user may use a remote device to switch channels on the STB, or to provide input for controlling other functions on the STB. The remote device may be used, for example, for controlling the STB's digital video recorder (DVR), for accessing a digital television programming guide, or for turning on or off specific settings on the STBs (e.g., turning on closed captioning, setting display width, etc.).

### BRIEF DESCRIPTION OF THE DRAWINGS

FIGS. 1A-1D are diagrams that depict an exemplary overview of the targeting of purchase offers for digital content to customers , where the purchase offers offer the digital content at a specific price for a specific customer purchasing participation level;

FIG. 2 is a diagram that illustrates an exemplary network environment in which the purchase offers of FIGS. 1A-1D may be targeted to customers via customer devices;

FIG. 3A is a diagram that depicts exemplary components of the offer campaign server of FIGS. 1A and 2;

FIG. 3B is a diagram that depicts exemplary functional components of the offer campaign server of FIGS. 1A and 2;

FIG. 4 depicts exemplary components of a set-top box;

FIG. 5 is a flow diagram that illustrates an exemplary process for generating and presenting a purchase offer to a targeted group of customers during an offer period associated with the purchase offer;

FIGS. 6A and 6B are diagrams that depict exemplary messaging associated with the process of FIG. 5;

FIG. 7 is a flow diagram that illustrates an exemplary process for presenting a purchase offer to a customer via a device of FIG. 1A;

FIG. 8 is a diagram that depicts an exemplary display of a purchase offer;

FIG. 9 is a diagram that depicts an exemplary display of a purchase offer status;

FIG. 10 is a flow diagram that illustrates an exemplary process for viewing a status of a purchase offer by a customer via a device of FIG. 1A; and

FIG. 11 is a diagram that depicts an exemplary purchase offer status page associated with a social networking site.

### DETAILED DESCRIPTION OF THE PREFERRED EMBODIMENTS

The following detailed description refers to the accompanying drawings. The same reference numbers in different drawings may identify the same or similar elements. The following detailed description does not limit the invention.

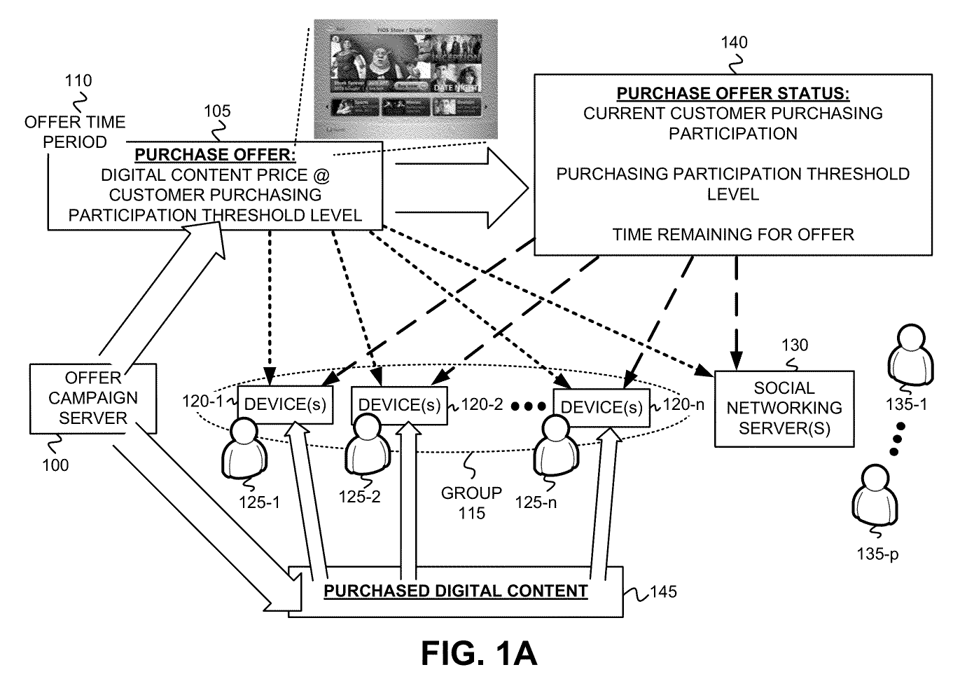

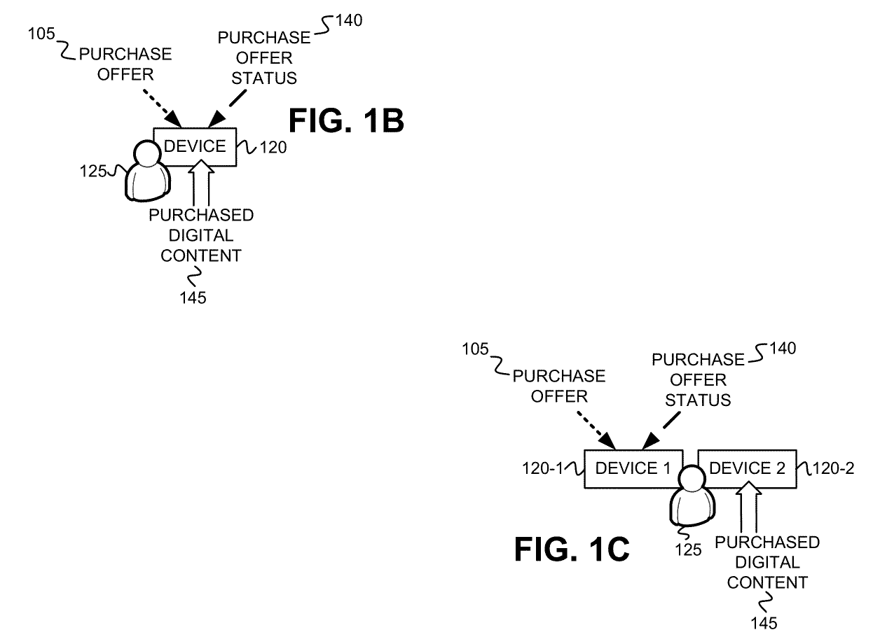

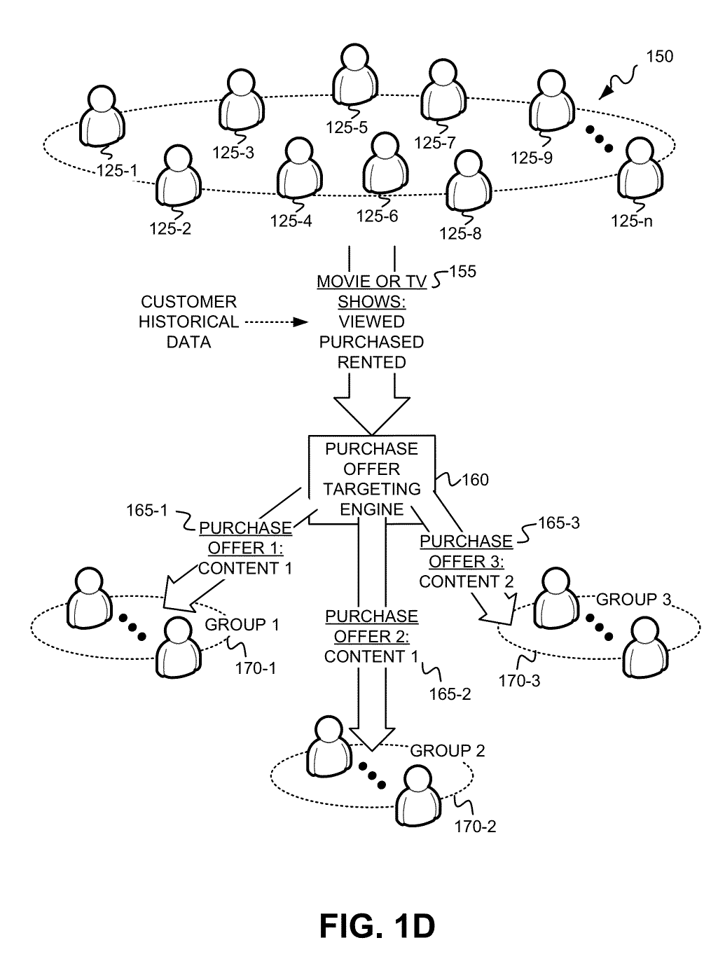

FIGS. 1A-1D illustrates an overview of the targeting of purchase offers for digital content to customers, where the purchase offers offer the digital content at a specific price for a specific customer purchasing participation level. As shown in FIG. 1A, an offer campaign server 100 may store a purchase offer 105 for sending to multiple different customers 125-1 through 125-n, during an offer time period 110, in a targeted group 115 of customers. The purchase offer 105 may include an offer for digital content at a discounted price that is tied to a number of customers that agree to purchase the digital content. The digital content may include audio and/or video content, such as, for example, TV shows or movies in a digital format that can be played back at device(s) 120-1 through 120-n. Device(s) 120-1 through 120-n may each include a single device, or multiple devices, that is associated with each respective customer 125-1 through 125-n. Device(s) 120 may include, for example, at least one of a set-top box (STB), a cellular telephone (e.g., a smart phone); a desktop, laptop, palmtop, or tablet computer; or a Personal Digital Assistant (PDA). In one example, device(s) 120 may include a single device, such as, for example, a customer 125 using a single STB or a single smart phone. In another example, device(s) 120 may include two devices, such as, for example, a customer 125 using a STB and a tablet computer.

Group 115 of customers may include multiple 125-1 through 125-n that have been targeted based on various types of data associated with each of customers 125-1 through 125-n, including historical data associated with each of customers 125-1 through 125-n. For example, the historical data may include data indicating TV shows and/or movies that each of customers 125-1 through 125-n has viewed, purchased and/or rented, data indicating channels to which customers 125-1 through 125-n have subscribed. Group 115 of customers 125-1 through 125-n may further be targeted based on other data, such as, for example, a same geographic region associated with customers 125-1 through 125-n. A customer purchasing-participation threshold level may be associated with a price to identify the number of aggregate customers that must agree to purchase the offered digital content for each of those customers to receive the discounted price. The purchase offer 105 may be offered over a specified time period 110 such that the offer may expire if the number of customers purchasing the product or service does not reach the customer purchasing participation threshold level prior to the offer time period expiring. For example, product A, normally sold for a price of $15, may be offered at a discounted price of $10 for a period of 1 day if 1000 or more customers agree to purchase product A prior to expiration of the single day. However, if at least 1000 customers do not agree to purchase product A prior to expiration of the single day, then the offer with the discounted price for product A expires.

As shown in FIG. 1A, in addition to providing purchase offer 105 to customers 125-1 through 125-n via devices 120-1 through 120-n, offer campaign server 100 may post purchase offer 105 on one or more social networking servers 130 such that users 135-1 through 135-p of social networking server(s) 130 may view and comment upon purchase offer 105. Users 135-1 through 135-p may include one or more of customers 125-1 through 125-n.

A purchase offer status 140 may be presented to customers 125-1 through 125-n at the time that customers 125-1 through 125-n agree to purchase the digital content offered for sale, or on-demand as requested by customers 125-1 through 125-n. Purchase offer status 140 may include a current customer purchasing participation value, the purchasing participation threshold level, and the time remaining for the offer. The current customer purchasing participation value indicates the number of customers who have agreed to purchase the offered digital content at the discounted price. The purchasing participation threshold level indicates the minimum total number of customers that must purchase the offered digital content for the purchases to be fulfilled. The time remaining for the offer indicates the time that is left before the offer time period 110 expires. As depicted in FIG. 1A, purchase offer status 140 may also be presented to social networking users 135-1 through 135-p, including customers 125-1 through 125-n, via social networking server(s) 130.

If, subsequent to presentation of purchase offer 105 to group 115 of customers 125-1 through 125-n, and prior to expiration of offer time period 110, the number of customers 125-1 through 125-n that agree to purchase the offered digital content at the discounted price equals or exceeds the purchasing participation threshold level, then the purchased digital content 145 may be made available to participating ones of customers 125-1 through 125-n via respective ones of devices 120-1 through 120-n. The purchased digital content 145 may be made available to the participating ones of customers 125-1 through 125-n as described below with respect to FIGS. 1B and 1C.

FIG. 1B depicts an overview of an exemplary embodiment in which purchase offers and purchased digital content are provided to a customer 125 via a single device 120. As shown, device 120 may receive purchase offer 105, and a subsequent purchase offer status 140, and display purchase offer 105 and purchase offer status 140 to customer 125. If the number of customers that agree to purchase the offered digital content at the discounted price equals or exceeds the purchasing participation threshold level, then purchased digital content 145 may be made available to customer 125 at the same device 120 at which the purchase offer 105 and/or purchase offer status 140 was received and displayed. In the embodiment of FIG. 1B, device 120 may include a single STB, a single smart phone, a single tablet computer, etc.

FIG. 1C depicts an overview of another exemplary embodiment in which purchased digital content is provided to a customer 125 via a different device than purchase offers. As shown, device 1 120-1 may receive purchase offer 105, and a subsequent purchase offer status 140, and display purchase offer 105 and purchase offer status 140 to customer 125. If the number of customers that agree to purchase the offered digital content at the discounted price equals or exceeds the purchasing participation threshold level, then purchased digital content 145 may be made available to customer 125 at a different device 2 120-2 than device 1 120-1. For example, purchase offer 105 and purchase offer status 140 may be received and displayed at a smart phone, and purchased digital content 145 may be made available to customer 125 at a STB. As another example, purchase offer 105 and purchase offer status 140 may be received and displayed at a PDA, and purchased digital content 145 may be made available to customer 125 at a tablet computer.

FIG. 1D depicts an overview of the targeting of purchase offers to certain groups of customers based on historical data associated with those customers. As shown in FIG. 1D, a first group 150 of customers 125-1 through 125-n may subscribe to a network service. For example, the network service may include a cable network service that provides video content (e.g., TV shows and movies in digital format) to customers 125-1 through 125-n via a cable network. Customer historical data 155 associated with digital content viewed or accessed by customers 125-1 through 125-n may be accumulated. For example, a cable network service provider may monitor and collect data regarding what movies or TV shows that each of customers 125-1 through 125-n has viewed, has purchased, or has rented. A purchase offer targeting engine 160 may analyze customer historical data 155, possibly in conjunction with other data, to target purchase offers involving selected digital content to sub-groups of group 150.

As shown in the example of FIG. 1D, purchase offer targeting engine 160 may determine a first group 170-1 of customers, based on customer historical data 155, to offer 165-1 first digital content at a certain price and customer purchasing participation threshold level. Purchase offer targeting engine 160 may also determine a second group 170-2 of customers, based on customer historical data 155, to offer 165-2 the first digital content at a different price and customer purchasing participation threshold level. Purchase offer targeting engine 160 may further determine a third group 170-3 of customers, based on customer historical data 155, to offer 165-3 second digital content at a certain price and customer purchasing participation threshold level. Each of groups 170-1 through 170-3 may include the same or different customers than every other group, depending on the targeting performed by purchase offer targeting engine 160.

Purchase offer targeting engine 160 may, therefore, generate multiple different purchase offers, the digital content, offer price and customer purchasing participation threshold level of which is targeted to a specific group of customers based on, among other data, customer historical data 155. For example, if each customer in a group of customers has previously rented a science fiction movie, then purchase offer targeting engine 160 may offer a newly released, different science fiction movie to those customers at a certain price and a certain customer purchasing participation threshold.

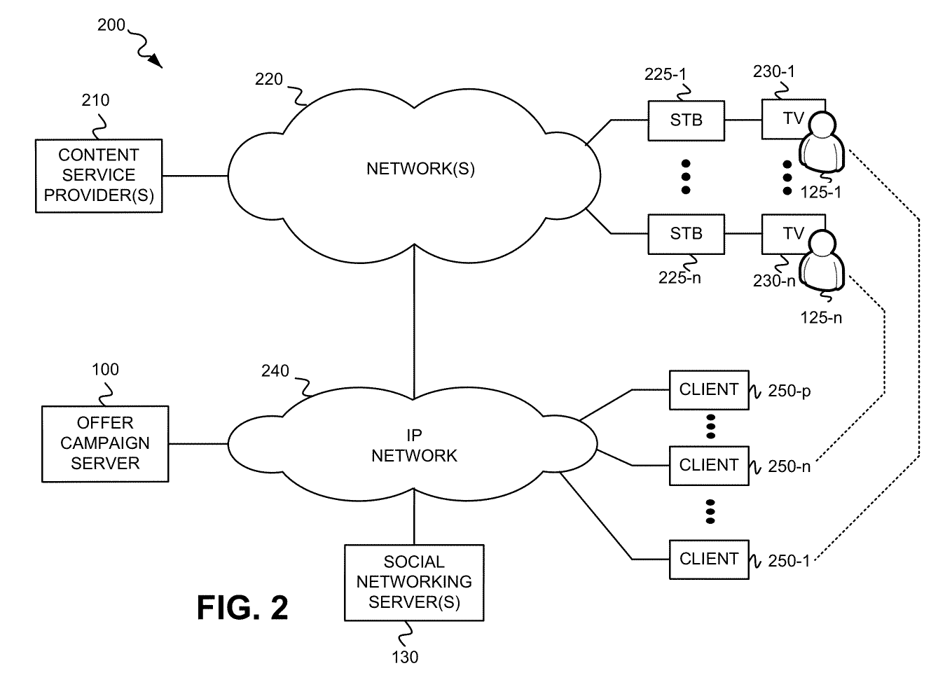

FIG. 2 is a diagram that illustrates an exemplary network environment 200 in which the purchase offers of FIG. 1 may be provided to customers via STBs. Network environment 200 may include a content service provider(s) 210, a network(s) 220, STBs 225-1 through 225-n, display devices 230-1 through 230-n, offer campaign server 100, an Internet Protocol (IP) network 240, a social networking server(s) 130, and client devices 250-1 through 250-p. STBs 225-1 through 225-n and client devices 250-1 through 250-p may correspond to device(s) 120-1 through 120-n in FIG. 1A. As shown in FIG. 2, each of customers 125-1 through 125-n may use multiple different devices 120, such as a STB 225 and a client device 250. For example, as shown in FIG. 2, customer 125-1 may use STB 225-1 and client device 250-1. Similarly, customer 125-n may use STB 225-n and client device 250-n.

Content service provider(s) 210 may include one or more devices, or a network of devices, that may deliver programming content to STBs 225-1 through 225-n via one or more channels over network 220. The content may include, for example, video programming content. The channels may include, for example, Quadrature Amplitude Modulated (QAM) High Definition (HD) channels (Motion Picture Experts Group-2 (MPEG-2) or MPEG-4), QAM standard definition (SD) channels (MPEG-2 or MPEG-4), Internet Protocol Television (IPTV) HD channels (MPEG-2 or MPEG-4), or IPTV SD channels.

Network(s) 220 may include any type of network, or combination of networks, that may provide programming content to STBs 225-1 through 225-n via one or more channels. In one exemplary implementation, network(s) 220 may include a cable network such as, for example, a fiber optic cable network, that carries content (e.g., video programming content) from content service provider(s) 210 to STBs 225-1 through 225-n. One or more other types of networks may alternatively be used for network(s) 220. For example, network(s) 220 may include a wireless satellite network, a wireless public land mobile network (PLMN) (e.g., a Code Division Multiple Access (CDMA) 2000 PLMN, a Global System for Mobile Communications (GSM) PLMN, a Long Term Evolution (LTE) PLMN and/or other types of PLMNs), a telecommunications network (e.g., a Public Switched Telephone Network (PSTN)), a local area network (LAN), a wide area network (WAN), a metropolitan area network (MAN), an intranet, and/or the Internet.

STBs 225-1 through 225-n (generically and individually referred to herein as “STB 225”) may each include an information appliance device that, among other components, includes a tuner and connects to a respective television (TV) 230-1 through 230-n. STBs 225-1 through 225-n may receive an external source of signal (e.g., content from content service provider(s) 210 via network 220) and may turn the signal into content that is displayed on a respective TV 230-1 through 230-n, or other type of display device.

Offer campaign server 100 may include a network device that generates and stores purchase offers, as described above with respect to FIGS. 1A-1D, that may be presented to customers 125-1 through 125-n via respective STBs 225-1 through 225-n and/or client devices 250-1 through 250-n. Offer campaign server 100 is depicted as connecting to IP network 240 but, in other implementations, may connect to network 220.

IP network 240 includes a network that uses Internet Protocol (IP) for carrying to and from offer campaign server 100, client devices 250-1 through 250-p, and STBs 225-1 through 225-n. Network 220 may, in some implementations, implement a portion of IP network 240 such that STBs 225-1 through 225-n may, for example, receive content over network 220 via QAM channels, and purchase offers via IP over IP network 240 and network 220. IP network 240 may include, for example, a local area network (LAN), a wide area network (WAN), a metropolitan area network (MAN), an intranet, and/or the Internet. IP network 240 may include one or more other types of packet switching networks.

Social networking server(s) 130 may include a network device(s) that hosts one or more social networking sites. Such social networking services may include, for example, Facebook, Twitter, YouTube, or similar types of social networking sites.

Client device 250-1 through 250-p may include any type of client device that may send or receive data via IP network 240. Clients 250-1 through 250-p may each include, for example, a desktop, laptop, palmtop, or tablet computer; a phone (e.g., smartphone); a personal digital assistant (PDA); or other type of computational device that can communicate via with IP network 240. Client devices 250-1 through 250-n may be associated with, and be used by, respective customers 125-1 through 125-n.

The configuration of network components of network environment 200 in FIG. 2 is for illustrative purposes only. Other configurations may be implemented. Therefore, network environment 200 may include additional, fewer and/or different components than those depicted in FIG. 2.

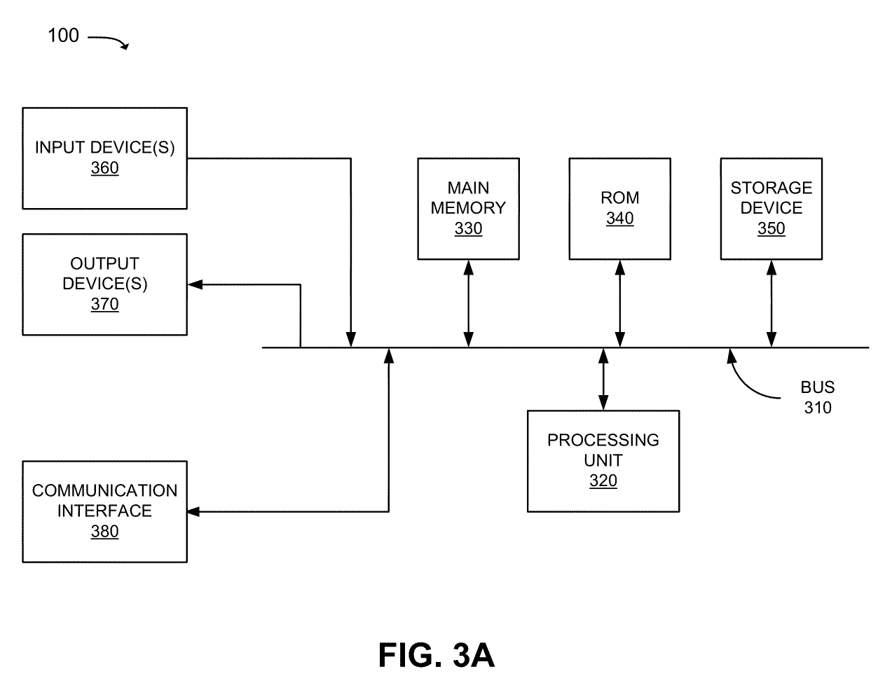

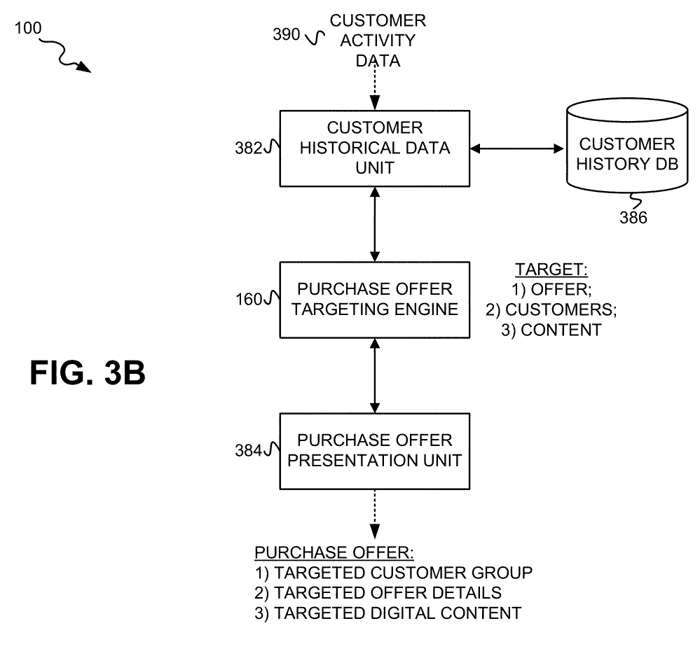

FIG. 3A is a diagram of exemplary components of offer campaign server 100. Social networking server(s) 130 and client devices 250-1 through 250-p may be similarly configured. Server 100 may include a bus 310, a processing unit 320, a main memory 330, a read only memory (ROM) 340, a storage device 350, an input device(s) 360, an output device(s) 370, and a communication interface 380. Bus 310 may include a path that permits communication among the elements of server 100.

Processing unit 320 may include one or more processors or microprocessors, or processing logic, which interprets and executes instructions. Main memory 330 may include a random access memory (RAM) or another type of dynamic storage device that stores information and instructions for execution by processing unit 320. ROM 340 may include a ROM device or another type of static storage device that stores static information and instructions for use by processing unit 320. Storage device 350 may include a magnetic and/or optical recording medium.

Input device 360 may include one or more mechanisms that permit an operator to input information to server 100, such as, for example, a keypad or a keyboard, a display with a touch sensitive panel, voice recognition and/or biometric mechanisms, etc. Output device 370 may include one or more mechanisms that output information to the operator, including a display, a speaker, etc. Communication interface 380 may include any transceiver that enables server 100 to communicate with other devices and/or systems. For example, communication interface 380 may include wired or wireless transceivers for communicating via network 240 and/or network(s) 220.

The configuration of components of server 100 in FIG. 3 is for illustrative purposes only. Other configurations may be implemented. Therefore, server 100 may include additional, fewer and/or different components than those depicted in FIG. 3.

FIG. 3B is a diagram of exemplary functional components of offer campaign server 100. The functional components shown in FIG. 3B may be implemented in hardware and/or software within offer campaign server 100. For example, in one implementation, the functional components of FIG. 3B may be implemented as instructions stored in memory 330 that are executed by processing unit 320. The functional components of offer campaign server 100 may include a customer historical data unit 382, a purchase offer targeting engine 160, a purchase offer presentation unit 384, and a customer history database (DB) 386.

Customer historical data unit 382 may monitor customer activity data 390, such as, for example, customer interaction with a network service. As one example, if customers 125-1 through 125-n subscribe to a cable network service, then customer historical data unit 382 may monitor the movies and/or TV shows that the customers view, purchase and/or rent. Customer historical data unit 382 may store the monitored activity for each customer in a customer profile in customer history DB 386. Customer history DB 386 may store a data structure, such as, for example, a database, which may store, among other data, customer historical data obtained by unit 382.

Purchase offer targeting engine 160 may determine targeted purchase offers of selected digital content, including a price, a customer purchasing participation threshold level, and an offer period, based on customer historical data stored in customer history DB 386. Purchase offer targeting engine 160 may further target groups of customers to who to offer the determined purchase offers also based on the customer historical data stored in customer history DB 386. Purchase offer targeting engine 160 may determine a given purchase offer and/or target a given group of customers based on, for example, the movies and/or TV shows that each of the customers has viewed, purchased and/or rented over a certain period of time. Purchase offer presentation unit 384 may obtain the determined purchase offers and present the purchase offers to the targeted groups of customers via network 220 and/or 240.

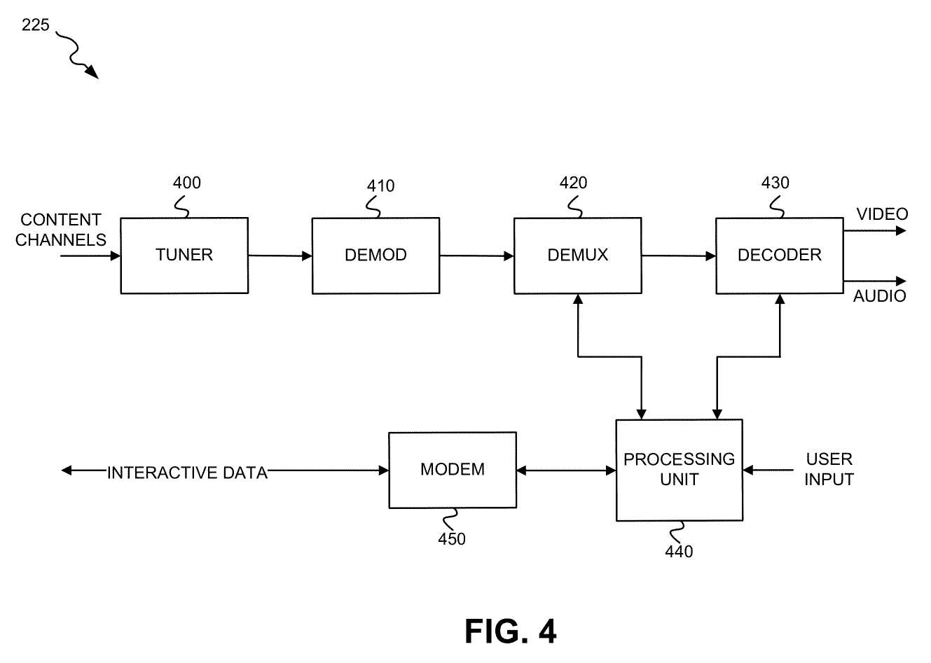

FIG. 4 depicts exemplary components of STB 225. STB 225 may include a tuner 400, a demodulator 410, a demultiplexer 420, a decoder 430, a processing unit 440, and a modem 450. Tuner 400 may select and tune to specific broadcast television information by tuning to one of many different input channels. Each channel may be digitally modulated using, for example, QAM, though other types of modulation may be used. Demodulator 410 may demodulate the information in the channel selected by tuner 400 to produce a transport stream (e.g., MPEG-2 or MPEG-4 transport stream) containing the audio, video and/or other information related to the selected TV program.

Demultiplexer 420 may select and decrypt compressed audio and video from the transport stream for the particular TV program that the STB user wishes to watch. Decoder 430 may decode and decompress the decrypted audio and video information for the selected TV program. Processing unit 440 may include, for example, a microprocessor that controls the operations performed by tuner 400, demodulator 410, demultiplexer 420 and decoder 430 based on user input (e.g., input received from a customer 125 via a remote control device). Modem 450 may send and receive interactive data (e.g., digital program guide information) that may be processed by processing unit 440.

The configuration of components of STB 225 in FIG. 4 is for illustrative purposes only. Other configurations may be implemented. Therefore, STB 225 may include additional, fewer and/or different components than those depicted in FIG. 4.

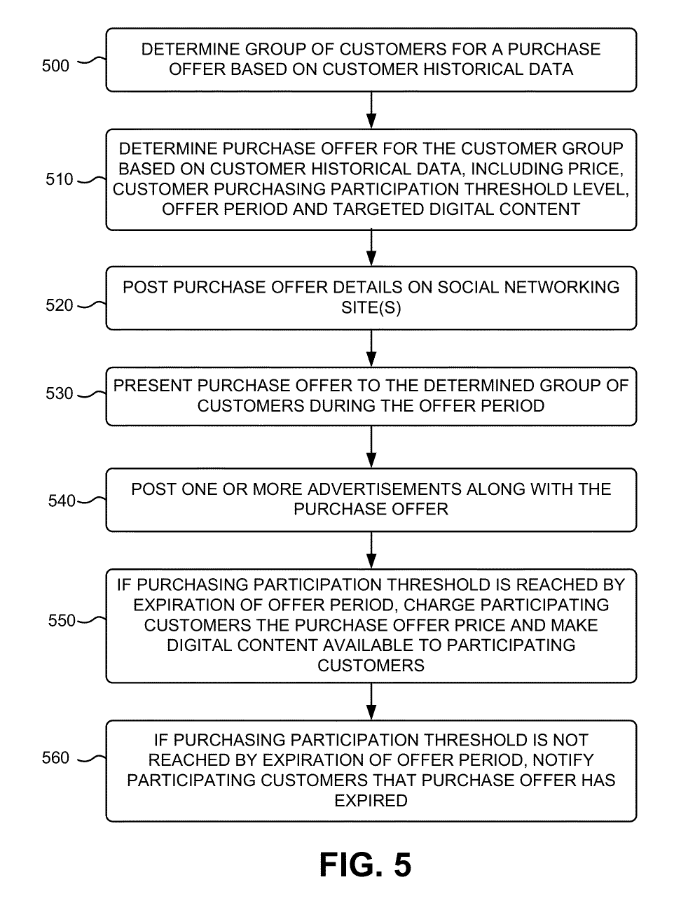

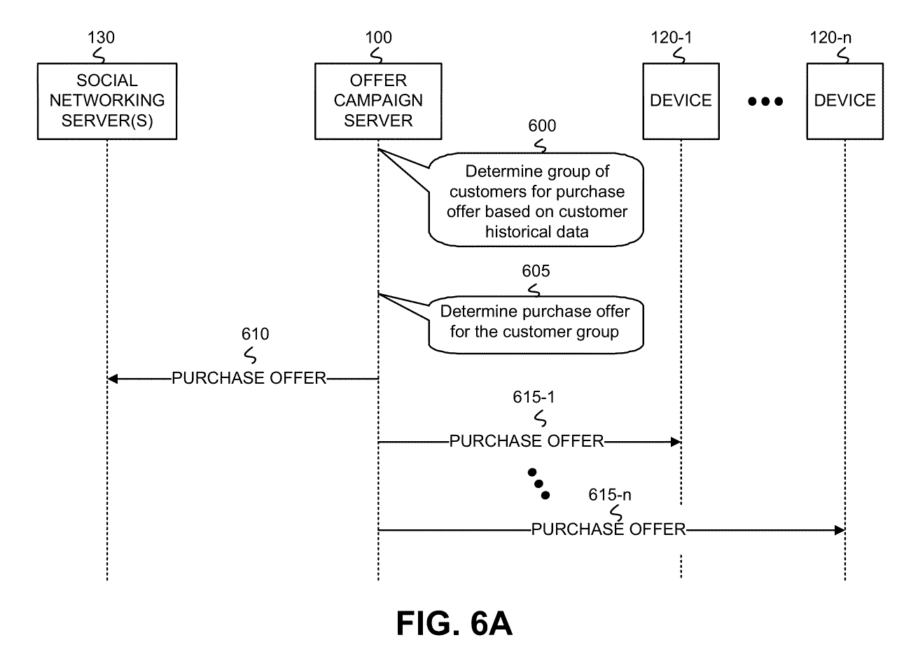

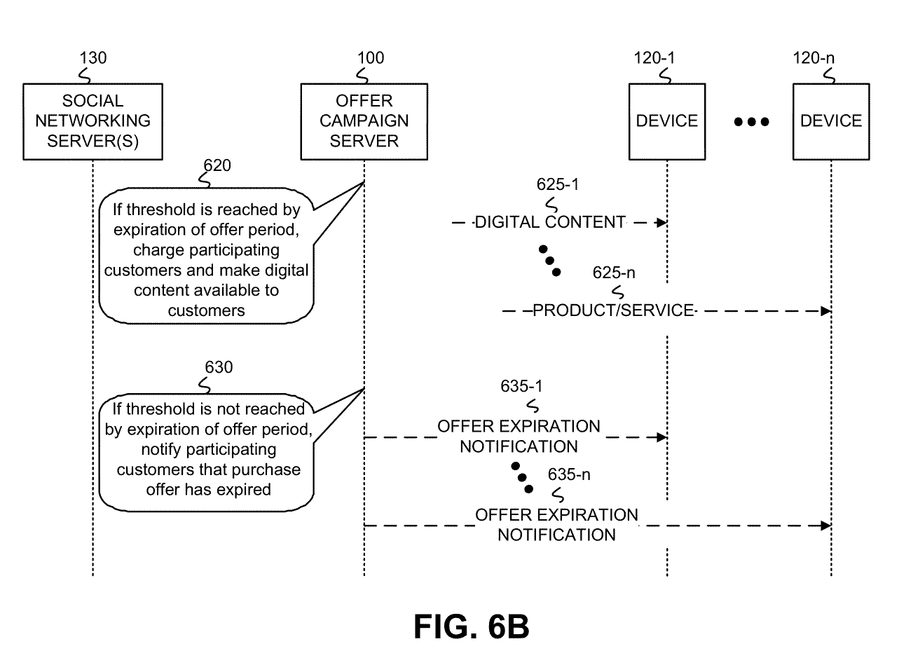

FIG. 5 is a flow diagram that illustrates an exemplary process for generating and presenting a purchase offer to a targeted group of customers during an offer period associated with the purchase offer. The exemplary process of FIG. 5 may be implemented by offer campaign server 100. The exemplary process of FIG. 5 is described below with reference to the messaging diagrams of FIGS. 6A and 6B.

The exemplary process may include purchase offer targeting engine 160 determining a group of customers for a purchase offer based on customer historical data (block 500). Purchase offer targeting engine 160 may retrieve customer historical data from customer history DB 386 and analyze the data to target a group of customers for a given purchase offer. For example, if a group of customers of customers 125-1 through 125-n have all watched situation comedy TV shows in the past three months, then the group may be identified for offering a discounted price on a certain comedy movie. As graphically depicted in FIG. 6A, offer campaign server 100 may determine 600 a group of customers for a purchase offer based on the customer historical data.

Purchase offer targeting engine 160 may determine a purchase offer for the customer group based on customer historical data, including the offer price, the customer purchasing participation threshold level, the offer period, and the targeted digital content (block 510). The details of the purchase offer for the customer group targeted in block 500 may be generated based on, among other data, the customer historical data. For example, purchase offer targeting engine 160 may retrieve movie renting history from customer history DB 386 to identify an average past price at which the group of customers has rented movies. The offer price for the purchase offer may be based on the identified average past price. FIG. 6A graphically depicts server 100 determining 605 the purchase offer for the customer group.

Server 100 may post details of the purchase offer on a social networking site(s) (block 520). Server 100 may send, via network 240, the details of the purchase offer to social networking server(s) 130. FIG. 6A depicts server 100 sending a message 610 that includes the purchase offer to social network server(s) 130. Server 100 may present the purchase offer to the determined group of customers during the offer period (block 530). For example, as shown in FIG. 1A, server 100 may present the purchase offer 105 to customers 125-1 through 125-n within targeted group 115 of customers. FIG. 6A depicts server 100 sending messages 615-1 through 615-n, containing the purchase offer, to respective devices 120-1 through 120-n.

Server 100 may post one or more advertisements along with the purchase offer (block 540). An administrator associated with server 100 may sell ad-space to other entities for posting in conjunction with the purchase offer. Server 100 may send the one or more advertisements to social networking server(s) 130 for posting along with the purchase offer. Additionally, or alternatively, server 100 may send the one or more advertisements to devices 120-1 through 120-n along with the purchase offer.

Server 100 may charge participating customers the purchase offer price, and make the digital content available to the participating customers, if the purchasing participating threshold for the purchase offer is reached by the expiration of the offer period (block 550). Server 100 may maintain billing records for customers, and may generate a billing record for each customer indicating that the customer has purchased the digital content at the purchase offer price. In one implementation, the billing record may be used to generate a bill that may be sent in electronic or hard copy form to the customer. In another implementation, each customer's debit or credit card information may be maintained at server 100, and the purchase offer price may be charged directly to the customer's debit of credit card. FIG. 6B depicts server 100 charging 620 participating customers and making the digital content available to the customers if the purchasing threshold is reached by expiration of the offer period. FIG. 6B further depicts server 100 sending a message 625-1 through 625-n to each respective device 120-1 through 120-n with a notification that the digital content is available to the respective customer. As described with respect to the embodiment of FIG. 1B, the purchased digital content 145 may be made available to customer 125 at a same device 120 to which the purchase offer was presented in block 520. Furthermore, as described with respect to the embodiment of FIG. 1C, the purchased digital content 145 may be made available to customer 125 at a different device 120-2 than the device 120-1 to which the purchase offer was presented in block 520.

Server 100 may notify participating customers that the purchase offer has expired, and purchases won't be fulfilled, if the purchasing participation threshold is not reached by expiration of the offer period (block 560). In the event that the offer period expires prior to the number of purchasers in group 115 of customers 125-1 through 125-n reaching the purchasing participation threshold, then the purchase offer is considered to have expired and the offer is withdrawn. As shown in FIG. 6B, server 100 may notify 630 participating customers that the purchase offer has expired if the purchasing threshold is not reached by expiration of the offer period, and may send a message 635-1 through 635-n to respective devices 120-1 through 120-n notifying the customers that the purchase offer is withdrawn, and won't be fulfilled.

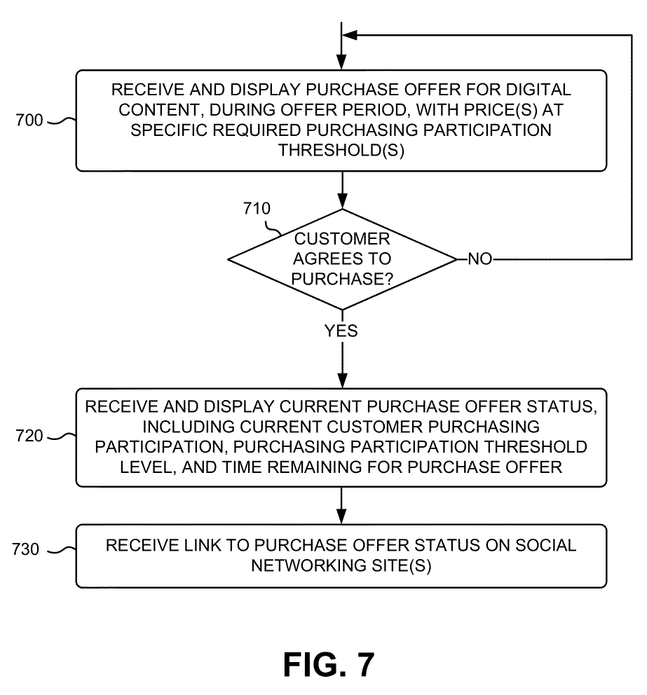

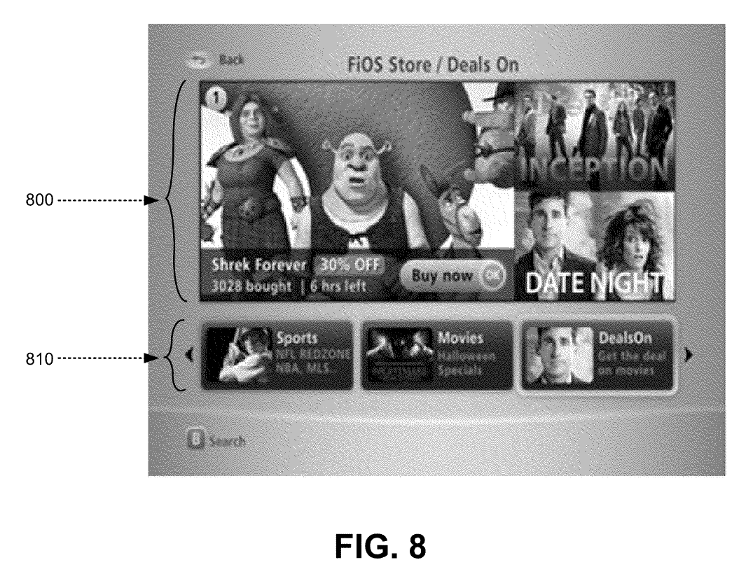

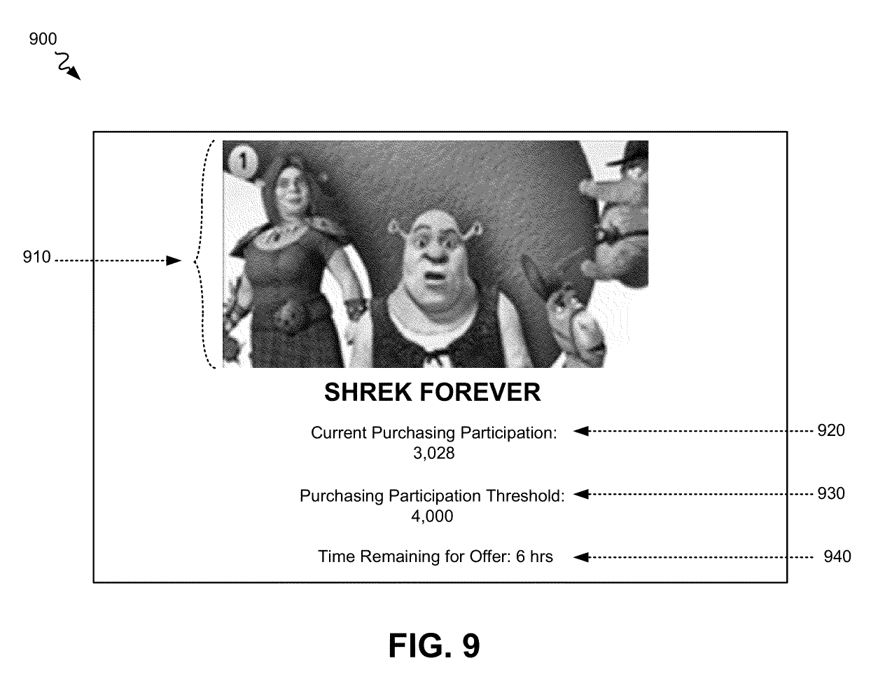

FIG. 7 is a flow diagram that illustrates an exemplary process for presenting a purchase offer to a customer 125 via a device(s) 120 (e.g., STB 225 and TV 230). The exemplary process of FIG. 7 may be implemented by device(s) 120. The exemplary process of FIG. 7 is described below with reference to the diagrams of FIGS. 8 and 9.

The exemplary process may include receiving and displaying a purchase offer for a digital content, during an offer period, with a price(s) at a specific required purchasing participation threshold(s) (block 700). Device 120 may receive a message containing the details of the purchase offer from server 100. As shown in FIG. 8, device(s) 120 may display the purchase offer 800. The displayed purchase offer 800 may include a description of the offered product or service, the price and the corresponding required purchasing participation threshold. As further shown in FIG. 8, the displayed purchase offer 800 may also include additional ads 810 displayed in conjunction with purchase offer 800.

Device(s) 120 may determine if the customer agrees to purchase the product or service (block 710). Customer 125 may agree to accept the purchase offer by providing input to device(s) 120 via, for example, a remote control device. Device(s) 120 may receive and display a current purchase offer status for the purchase offer, including current customer purchasing participation, the purchasing participation threshold level, and the time remaining for the purchase offer (block 720). Upon receipt of the acceptance of the purchase offer from device(s) 120, server 100 may provide the purchase offer status to device(s) 120 for display. As shown in FIG. 9, a purchase offer status 900 may identify the digital content 910, may indicate a current purchasing participation 920, a purchasing participation threshold 930, and a time remaining in the offer period before the purchase offer expires. Device(s) 120 may receive a link to the purchase offer status on a social network site(s) (block 730). The link may permit customer 125 to access the social networking site(s) at social networking server(s) 130 to view the purchase offer status in addition to information about the purchase offer posted by other social networking site users (e.g., whether the users “like” or “dislike” the purchase offer). The social networking site users may post their own evaluation of the purchase offer, or other comments related to the purchase offer.

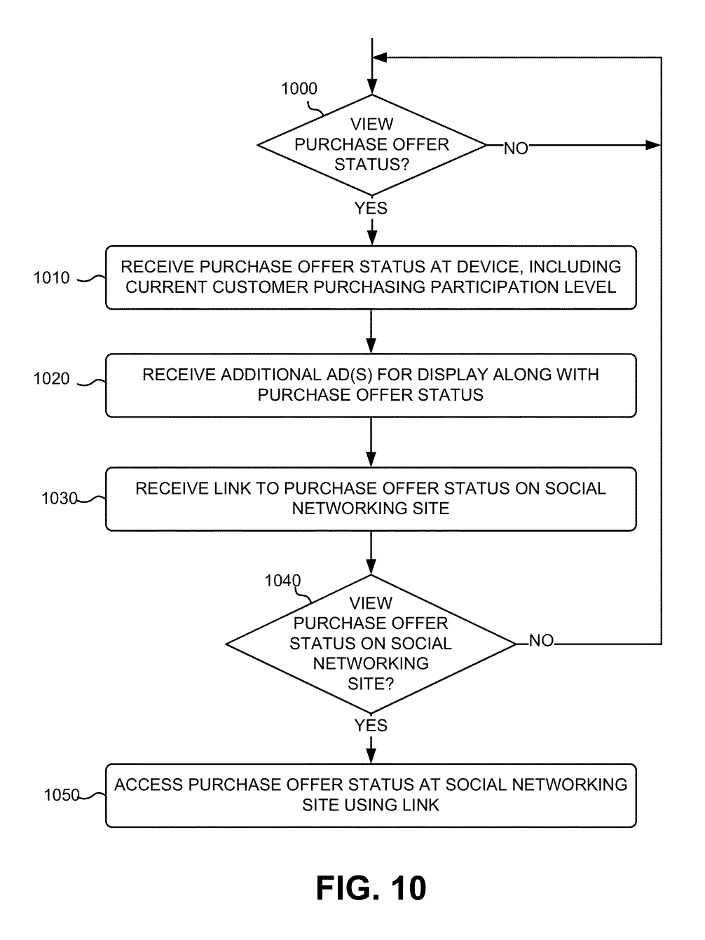

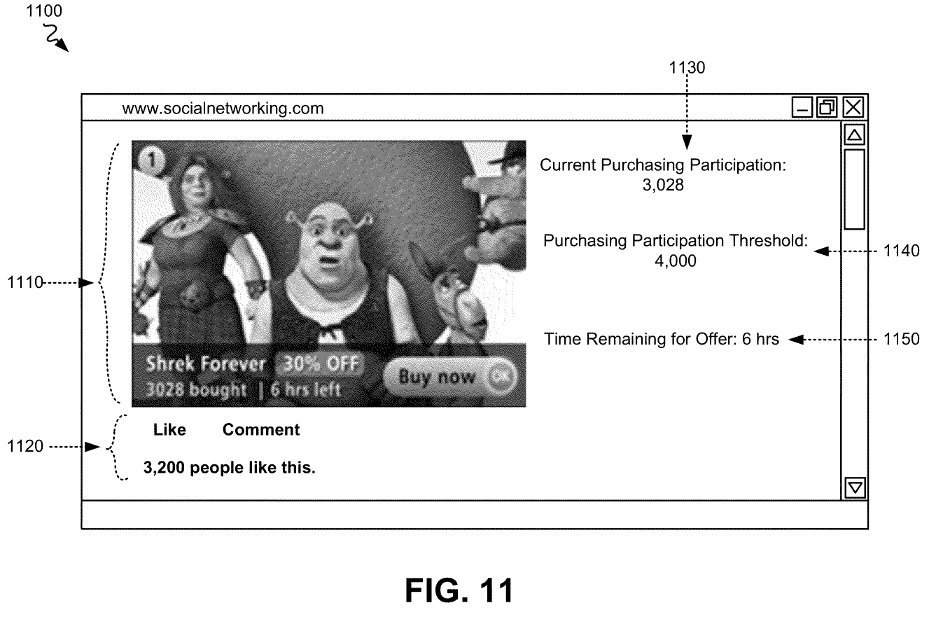

FIG. 10 is a flow diagram that illustrates an exemplary process for viewing a status of a purchase offer by a customer via a device(s) 120. The exemplary process of FIG. 10 may be implemented by device(s) 120. The exemplary process of FIG. 10 is described below with reference to FIG. 11.

The exemplary process may include device(s) 120 determining if customer 125 has requested to view a purchase offer status (block 1000). Subsequent to customer 125 agreeing to purchase the product or service of the purchase offer (as occurred in block 710 of FIG. 7), customer 125 may wish to view a status of the purchase offer to determine whether the purchasing participation threshold level has been met prior to expiration of the offer period. Customer 125 may provide input to device(s) 120 requesting the viewing of the purchase offer status. If customer 125 requests to view the purchase offer status (YES-block 1000), then device(s) 120 may receive the purchase offer status, including the current customer purchasing participation level (block 1010). Referring back to FIG. 9, device(s) 120 may display the purchase offer status, including the current customer purchasing participation 920, the purchasing participation threshold 930, and the time remaining 940 in the offer period.

Device(s) 120 may receive additional ads for display along with the purchase offer status (block 1020). STB 120 may display the ads in conjunction with the purchase offer status 910 shown in FIG. 9. STB 120 may receive a link to the purchase offer status on a social networking site (block 1030) and may determine if customer 125 has requested to view the purchase offer status on the social networking site (block 1040). If customer 125 has requested to view the purchase offer status on the social networking site (YES-block 1040), then STB 120 may access the purchase offer status at the social networking site using the link (block 1050). The social networking site link may permit customer 125 to connect to social networking server (s) 130 to view the purchase offer status, and the associated posted user comments, etc. FIG. 11 depicts a purchase offer status page stored at social networking server(s) 130 that includes an identification of the purchase offer 1110, social networking site user comments 1120 regarding the purchase offer, a current purchasing participation 1130, a purchasing participation threshold 1140, and a time remaining 1150 in the offer period. Alternatively, blocks 1040 and 1050 may be implemented as a stand-alone process by a client 250.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 5, 7, and 10, the order of the blocks may be varied in other implementations. Moreover, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
presenting, to a first customer via a first device, a purchase offer for digital content, during an offer period, wherein the purchase offer includes a price at a required purchasing participation threshold;
receiving input from the first customer at the first device;
determining, at the first device, if the first customer agrees to the purchase offer based on the first customer's input;
presenting to the first customer a current status associated with the purchase offer, the current status including a current customer participation in the purchase offer, the required purchasing participation threshold, and time remaining in the offer period; and
presenting, to the first customer, a link to the current status of the purchase offer at a social networking site.

2. The method of claim 1, wherein the required purchasing participation threshold comprises a number of customers that must agree to purchase the digital content at the price for the purchase offer to be fulfilled.

3. The method of claim 1, wherein the current customer participation in the purchase offer comprises a number of customers that has currently agreed to purchase the digital content at the price.

4. The method of claim 1, further comprising:
targeting a group of customers based on customer profile data, wherein the group comprises the first customer and a second customer.

5. The method of claim 4, wherein the first device comprises one of a set-top box (STB), a cellular telephone; a desktop, laptop, palmtop, or tablet computer; or a Personal Digital Assistant (PDA).

6. The method of claim 4, further comprising:
presenting, to the second customer via a second device, the purchase offer for the digital content, during the offer period, wherein the purchase offer includes the price at the specific required purchasing participation threshold;
receiving input from the second customer at the second device;
determining, at the second device, if the second customer agrees to the purchase offer based on the second customer's input;
presenting to the second customer the current status associated with the purchase offer, the current status including the current customer participation in the purchase offer; the required purchasing participation threshold, and time remaining in the offer period; and
presenting, to the second customer, the link to the current status of the purchase offer at the social networking site.

7. The method of claim 1, further comprising:
determining whether the required purchasing participation threshold has been reached by expiration of the offer period.

8. The method of claim 7, further comprising:
charging the purchase offer price to the first customer, and making the digital content available to the first customer, if the purchasing participation threshold was reached by expiration of the offer period.

9. The method of claim 8, wherein the digital content is made available to the first customer at a second device that is different than the first device.

10. The method of claim 7, further comprising:
notifying the first customer that the purchase offer has expired, and that the purchase offer will not be fulfilled, if the purchasing participation threshold was not reached by expiration of the offer period.

11. The method of claim 1, further comprising:
determining the purchase offer based on customer profile data, wherein the customer profile data comprises a profile of customer viewing, renting or purchasing behavior.

12. A device, comprising:
a communication interface configured to receive data, via Internet Protocol (IP), that details a purchase offer for digital content, wherein the purchase offer includes a price at a specific required purchasing participation threshold and an offer period,
wherein the required purchasing participation threshold comprises a number of customers that must agree to purchase the digital content at the price for the purchase offer to be fulfilled; and
a processor configured to:
present, to a first customer, the purchase offer for the product or service during the offer period,
determine if the first customer agrees to the purchase offer based on first customer input,
present, to the first customer, a current status associated with the purchase offer, the current status including a current customer participation in the purchase offer, the required purchasing participation threshold, and time remaining in the offer period,
wherein the current customer participation in the purchase offer comprises a number of customers that has currently agreed to purchase the product or service at the price, and
present, to the first customer, a link to a status of the purchase offer at a social networking site.

13. The network device of claim 12, wherein the device comprises one of a set-top box (STB), a cellular telephone; a desktop, laptop, palmtop, or tablet computer; or a Personal Digital Assistant (PDA).

14. A method, comprising:
receiving a purchase offer for digital content, wherein the purchase offer includes a price for the digital content at a required customer purchasing participation threshold;
targeting a group of customers based on customer profile data;
presenting the purchase offer to the group of customers, via a network and multiple devices, during the offer period;
charging participating customers from the group of customers the purchase offer price, if the purchasing participation threshold is reached by expiration of the offer period; and
notifying the participating customers of expiration of the purchase offer, if the purchasing participation threshold is not reached by the expiration of the offer period.

15. The method of claim 14, wherein the required customer purchasing participation threshold comprises a number of customers that must agree to purchase the digital content at the price for the purchase offer to be fulfilled.

16. The method of claim 14, wherein the devices each comprises one of a set-top box (STB), a cellular telephone; a desktop, laptop, palmtop, or tablet computer; or a Personal Digital Assistant (PDA).

17. The method of claim 14, further comprising:
making the digital content to the participating customers if the purchasing participation threshold is reached by the expiration of the offer period.

18. The method of claim 14, further comprising:
presenting the purchase offer to the group of customers via a network using Internet Protocol (IP).

19. The method of claim 14, further comprising:
determining the digital content, the price or the required customer purchasing participation threshold based on the customer profile data.

20. A network device, comprising:
a communication interface connected to a network;
a processor unit configured to:
receive details of a purchase offer for digital content, wherein the purchase offer includes a price for the digital content at a required customer purchasing participation threshold, wherein the required customer purchasing participation threshold comprises a number of customers that must agree to purchase the digital content at the price for the purchase offer to be fulfilled,
target multiple customers based on customer profile data,
present the purchase offer to the multiple customers, via the communication interface, the network, and multiple different devices associated with respective ones of the multiple customers, during the offer period;
charge participating customers the purchase offer price, if the purchasing participation threshold is reached by expiration of the offer period; and
notify the participating customers of expiration of the purchase offer, if the purchasing participation threshold is not reached by the expiration of the offer period.

21. The network device of claim 20, wherein the processing unit is further configured to:
determine the digital content, the price or the required purchasing participation threshold based on the customer profile data.

22. The network device of claim 20, wherein each of the multiple different devices comprises one of a set-top box (STB), a cellular telephone; a desktop, laptop, palmtop, or tablet computer; or a Personal Digital Assistant (PDA).

23. The network device of claim 20, wherein the processing unit is further configured to:
make the digital content available to the participating customers if the purchasing participation threshold is reached by the expiration of the offer period.
